(19) United States
(12) Patent Application Publication
(10) Pub. No.: US 2023/0396925 A1
(43) Pub. Date: Dec. 7, 2023

(54) IN-VEHICLE COMMUNICATION DEVICE AND NON-TRANSITORY COMPUTER-READABLE STORAGE MEDIUM

(71) Applicant: DENSO TEN Limited, Kobe-shi (JP)

(72) Inventor: Katsuaki HIKIMA, Kobe (JP)

(73) Assignee: DENSO TEN Limited, Kobe-shi (JP)

(21) Appl. No.: 18/073,218

(22) Filed: Dec. 1, 2022

(30) Foreign Application Priority Data
Jun. 7, 2022 (JP) 2022-092489

(51) Int. Cl. H04R 3/12; H04R 1/40; H04R 3/00; G10L 15/22; G10L 15/08

(52) U.S. Cl. CPC H04R 3/12; H04R 1/403; H04R 1/406; H04R 3/005; G10L 15/22; G10L 15/08; G10L 2015/088; H04R 2499/13; B60R 16/037

(57) ABSTRACT

An in-vehicle communication device includes: a controller to execute control for selecting at least one speaker from among a plurality of speakers in a vehicle interior, the at least one speaker outputting sound input into one of a plurality of microphones in the vehicle interior; a sound recognizer that recognizes a word included in the sound; and a memory that stores association information that associates the plurality of microphones and speakers with each other. The controller is further configured to: in a case where the sound recognizer recognizes that sound input into one of the plurality of microphones includes a specific word, based on the association information, execute control for causing a speaker of the plurality of speakers associated with the one microphone into which the sound is input, to output sound that is input subsequently to the specific word into the one microphone into which the sound is input.

### CROSS-REFERENCE TO RELATED APPLICATION

This application is based upon and claims the benefit of priority of the prior Japanese Patent Application No. 2022-092489, filed on Jun. 7, 2022, the entire contents of which are incorporated herein by reference.

### FIELD

The embodiments discussed herein are directed to an in-vehicle communication device and an in-vehicle communication method.

### BACKGROUND

Recently, In-Car-Communication (ICC) conversation becomes popular in a large-sized vehicle such as a minivan. The ICC has function having two types of 1Way-ICC and 2Way-ICC. The 1Way-ICC is function that causes a speaker of a rear seat to output sounds collected in a front seat.

On the other hand, the 2Way-ICC is function that causes a speaker of a rear seat to output sounds collected in a front seat, and further causes a speaker of the front seat to output sounds collected in the rear seat. By employing the 2Way-ICC, bidirectional communication is realized between a front seat and a rear seat.

A controller (for example, CPU) provided in an on-vehicle device such as a car audio device and a car navigation executes a program referred to as “2way-ICC solution” so as to realize the 2Way-ICC.

Note that the “solution” mentioned here indicates a “means” for executing function (herein, ICC function), thus is not limited to one that is implemented as a program executed by a controller as described above, and may include one that is implemented by hardware such as an application specific integrated circuit (ASIC), a field-programmable gate array (FPGA), and other digital circuits/analog circuits (the same applies hereafter).
Patent Literature 1: WO2018/167949
Patent Literature 2: Japanese Laid-Open Patent Publication No. 2006-101048

However, in the conventional technology, there presents a problem that processing load for realizing bidirectional communication between a front seat and a rear seat of a vehicle is large.

For example, in order to realize the bidirectional communication, the 2way-ICC solution includes two input channels corresponding to a microphone of a front seat and a microphone of a rear seat, and two output channels corresponding to a speaker of the front seat and a speaker of the rear seat.

The 2way-ICC solution executes echo cancellation on each of sounds output from the speaker of the front seat, and sounds output from the speaker of the rear seat.

As described above, 2way-ICC solution executes echo cancellation on sounds of two channels, whose load of a Central Processing Unit (CPU) is large. In a case where the ICC function is implemented by hardware, echo cancellers whose number is equivalent to that of channels need to be provided, so that a circuit scale thereof becomes large.

One aspect of the embodiments is made in view of the aforementioned, and an object of the embodiments is to provide an in-vehicle communication device and an in-vehicle communication method capable of reducing processing load of an echo canceller for bidirectional communication between a front seat and a rear seat of a vehicle, or capable of reducing increase in a circuit scale.

### SUMMARY

### Brief Description of Drawing(s)

FIG. 1 is a diagram illustrating a configuration example of a vehicle according to a first embodiment;

FIG. 2 is a diagram illustrating a configuration example of an in-vehicle communication system according to the first embodiment;

FIG. 3 is a diagram illustrating an example of mode information according to the first embodiment;

FIG. 4 is a flowchart illustrating a procedure of an in-vehicle communication method according to the first embodiment;

FIG. 5 is a diagram illustrating an example of mode information according to a second embodiment; and

FIG. 6 is a flowchart illustrating a procedure of an in-vehicle communication method according to the second embodiment.

### DESCRIPTION OF EMBODIMENTS

Hereinafter, embodiments of an in-vehicle communication device and an in-vehicle communication method will be described in detail with reference to the accompanying drawings. Moreover, the disclosed technology is not limited to the embodiments described below.

### First Embodiment

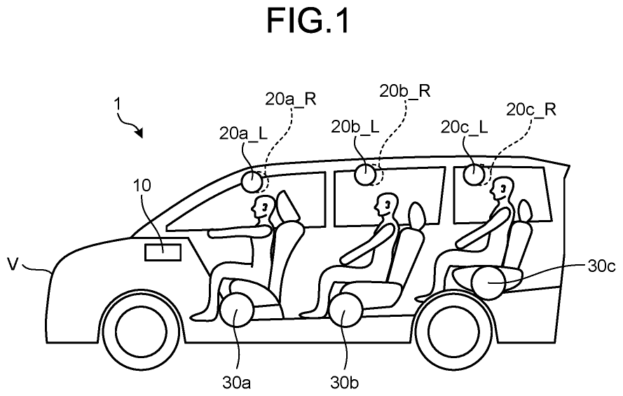

First, a vehicle according to embodiments will be explained with reference to FIG. 1. FIG. 1 is a diagram illustrating a configuration example of a vehicle according to a first embodiment.

As illustrated in FIG. 1, a vehicle V is a six-to-eight-passenger vehicle including three-row seats. The vehicle V includes an in-vehicle communication device 10.

The in-vehicle communication device 10 is a device that assists conversation between occupants getting on respective seats. For example, the in-vehicle communication device 10 causes a specific speaker to output sound that is input into a microphone.

In the vehicle interior, microphones (hereinafter, may be referred to as microphones) are provided, which are corresponding to respective seats. Moreover, in the vehicle interior, speakers are provided that are corresponding to respective seat-rows.

A microphone 20a_R is provided at a seat (hereinafter, may be referred to as right-front seat) on the right side in a front row (row including driver's seat). A microphone 20a_L is provided at a seat (hereinafter, may be referred to as left-front seat) on the left side in the front row.

A microphone 20b_R is provided at a seat (hereinafter, may be referred to as right-middle seat) on the right side in a middle row (row just behind front row). A microphone 20b_L is provided at a seat (hereinafter, may be referred to as left-middle seat) on the left side in the middle row.

A microphone 20c_R is provided at a seat (hereinafter, may be referred to as right-rear seat) on the right side in a rear row (row just behind middle row). A microphone 20c_L is provided at a seat (hereinafter, may be referred to as left-rear seat) on the left side in the rear row.

A speaker 30a, a speaker 30b, and a speaker 30c are arranged at a front row, a middle row, and a rear row, respectively.

An in-vehicle communication system 1 is a system including the in-vehicle communication device 10, the above-mentioned microphones, and the above-mentioned speakers.

For example, in a case where an occupant of a right-front seat communicates with an occupant of a right-middle seat, it is sufficient that the in-vehicle communication device 10 causes the speaker 30b to output sound that is input into the microphone 20a_R, and further causes the speaker 30a to output sound that is input into the microphone 20b_R.

Conventionally, in order to realize such a bidirectional communication, 2way-ICC solution is used, whose processing load is large.

On the other hand, the in-vehicle communication device 10 according to the first embodiment realizes bidirectional communication by using 1way-ICC solution so as to reduce processing load.

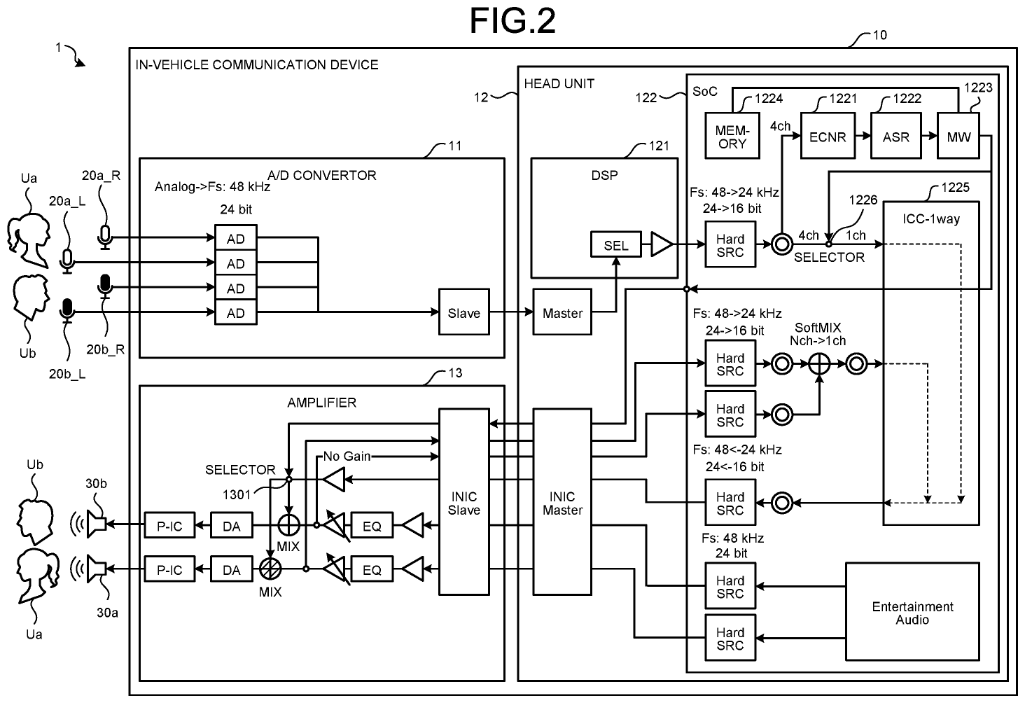

A configuration and processing of the in-vehicle communication system 1 will be explained with reference to FIG. 2. FIG. 2 is a diagram illustrating a configuration example of the in-vehicle communication system according to the first embodiment.

As illustrated in FIG. 2, sound is input into the in-vehicle communication device 10 from the microphone 20a_R, the microphone 20a_L, the microphone 20b_R, and the microphone 20b_L. In this case, four-channel sound is input into the in-vehicle communication device 10.

The number of channels of sound input into the in-vehicle communication device 10 is not limited to one illustrated in FIG. 2. For example, sound is input into the in-vehicle communication device 10 from the microphone 20c_R and the microphone 20c_L in some cases.

The in-vehicle communication device 10 causes the speaker 30a and the speaker 30b to output sound. The in-vehicle communication device 10 may further cause the speaker 30c to output sound.

The in-vehicle communication device 10 may be realized as a part of function of a car navigation system. Furthermore, the in-vehicle communication device 10 may use function of a car navigation system, such as voice recognition.

In the example illustrated in FIG. 2, assume that an occupant Ua is in a right-front seat with which the microphone 20a_R and the speaker 30a are associated. Assume that an occupant Ub is in a right-middle seat with which the microphone 20b_R is associated.

The in-vehicle communication device 10 includes an Analog-to-Digital (AD) convertor 11, a head unit 12, and an amplifier 13.

The A/D convertor 11 converts an input analog sound signal into a digital sound signal, and outputs the converted signal to the head unit 12. For example, the A/D convertor 11 converts an analog sound signal into a digital sound signal whose sampling frequency (Fs) is 48 kHz and whose quantization bit number is 24 bit.

In an interface between the A/D convertor 11 and the head unit 12, the A/D convertor 11 is on a slave side, and the head unit 12 is on a master side.

The head unit 12 includes a Digital Signal Processor (DSP) 121 and a System on a Chip (SoC) 122.

The SoC 122 is one example of a controller. The SoC 122 functions as a controller by processing of a Middleware (MW) 1223 to be mentioned later, for example.

The DSP 121 executes processing, such as filtering, on a digital sound signal received from the A/D convertor 11, and outputs the processed sound signal to the SoC 122.

Herein, by a Hard Sampling Rate Converter (SRC), a sampling frequency of the sound signal input to the SoC 122 is converted from 48 kHz to 24 kHz, and a quantization bit number thereof is converted from 24 bit to 16 bit.

By the Hard SRC, a sampling frequency of a sound signal output from the SoC 122 is converted from 24 kHz to 48 kHz, and a quantization bit number thereof is converted from 16 bit to 24 bit.

The SoC 122 includes an Echo Canceller and Noise Reduction (ECNR) 1221, an Automatic Speech Recognition (ASR) 1222, the Middleware (MW) 1223, an ICC-1way 1225, and a selector 1226. Note that each unit of the SoC 122 is realized by a program.

The ECNR 1221 removes noise such as travelling sound of the vehicle V.

The ASR 1222 executes speech recognition. For example, the ASR 1222 converts a sound signal into text by using a deep learning model. The ASR 1222 is capable of recognizing that the text includes a specific word. The ASR 1222 is one example of a sound recognizer.

The MW 1223 controls the selector 1226. Furthermore, the MW 1223 controls a selector 1301 of the amplifier 13, which is to be mentioned later.

The ICC-1way 1225 is 1way-ICC solution. For example, the ICC-1way 1225 executes echo cancellation on a sound signal of a single channel. Processing load of the ICC-1way 1225 is smaller than that of 2way-ICC solution.

An channel of a sound signal input into the ICC-1way 1225 is decided by the selector 1226 arranged before the ICC-1way 1225. A sound signal of a channel that is selected by the selector 1226 from among sound signals of a plurality of channels (four in example illustrated in FIG. 2) is input into the ICC-1way 1225.

The amplifier 13 is configured to execute equalization (EQ) on a digital sound signal output from the head unit 12, convert the digital sound signal into an analog sound signal, amplify the converted sound signal by using a power amplifier (P-IC), and cause a speaker to output sound.

The amplifier 13 executes MIX on a sound signal transmitted from the ICC-1way 1225 into a route connected to at least one of speakers. The selector 1301 is arranged before the MIX.

The selector 1301 is capable of selecting a speaker from which a sound signal transmitted from the ICC-1way 1225 is to be output.

In an interface (INIC: Intelligent Network Interface Controller) between the amplifier 13 and the head unit 12, the amplifier 13 is on a slave side, and the head unit 12 is on a master side.

A control method of selectors (selector 1226 and selector 1301) by the MW 1223 will be explained. The outline of the following processes to be explained may be applied not only to the MW 1223, but also to the SoC 122, the controller, or the like.

As described above, the selectors (selector 1226 and selector 1301) are capable of changing at least one of a plurality of speakers from which sound input into one of a plurality of microphones provided in the vehicle interior is output.

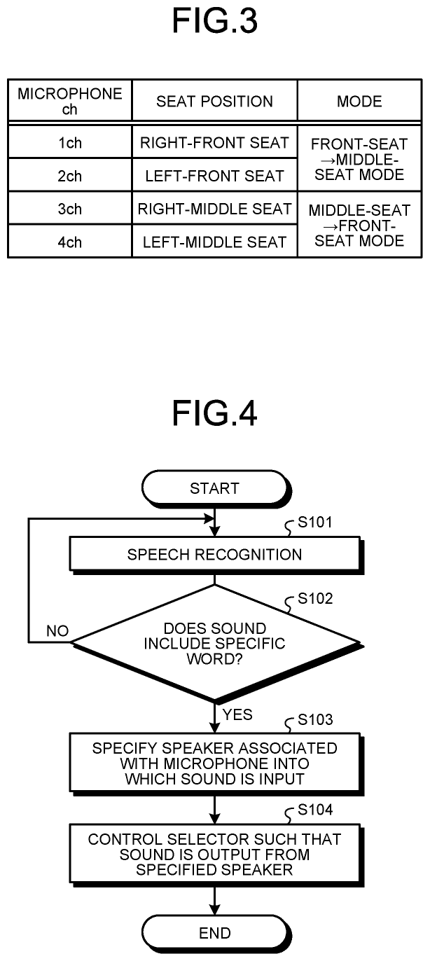

The MW 1223 controls a channel selected by a selector in accordance with mode information illustrated in FIG. 3. Assume that the mode information is stored in a memory 1224. FIG. 3 is a diagram illustrating an example of the mode information according to the first embodiment. The mode information illustrated in FIG. 3 may be one obtained by adding a column indicating modes to a table in which information identifying a microphone (microphone ch) and a position (seat position) of a seat are associated with each other.

The mode information is information in which a microphone and a mode are associated with each other. In other words, the mode information is information that indicates which speaker outputs sound that is input into one microphone, and further is information that associates a plurality of microphones and a plurality of speakers that are provided in a vehicle with each other.

A specific word for controlling a selector is previously added to a voice dictionary that is a list of words to be recognized by the ASR 1222. For example, assume that a word of “Hey ICC” is added to the voice dictionary as a specific word.

The MW 1223 is one example of a controller that is configured to execute control for selecting at least one of a plurality of speakers provided in the vehicle interior, which outputs sound that is input into one of a plurality of microphones provided in the vehicle interior. The in-vehicle communication device 10 includes, in addition to the MW 1223, a sound recognizer (ASR 1222) that recognizes a word included in sound and the memory 1224 that stores therein association information that associates a plurality of microphones and a plurality of speakers with each other. In a case where the sound recognizer recognizes that sound input into one of a plurality of microphones includes a specific word, the controller executes, on the basis of the association information, control for causing a speaker of a plurality of speakers, which is associated with the microphone into which the sound is input, to output sound that is input subsequently to the specific word into the microphone into which the sound is input. The mode information is one example of the association information.

Herein, the microphone 20a_R corresponds to 1 ch, the microphone 20a_L is corresponds to 2 ch, the microphone 20b_R is corresponds to 3 ch, and the microphone 20a_L corresponds to 4 ch.

The ASR 1222 executes speech recognition on each of sound signals of 1 ch, 2 ch, 3 ch, and 4 ch that are input into the SoC 122.

The MW 1223 controls the selector 1226 such that a sound signal of a channel in which “Hey ICC” is recognized by the ASR 1222 is input into the ICC-1way 1225.

Herein, the MW 1223 specifies a mode corresponding to the channel in which “Hey ICC” is recognized, with reference to mode information.

For example, in a case where a microphone ch is “1 ch” and a mode is “front-seat→middle-seat mode” in the mode information, the MW 1223 controls the selector 1301 such that MIX of a sound signal transmitted from the ICC-1way 1225 is executed into a route connected to the speaker on a side of a middle seat.

Thus, in a case where the occupant Ua in a front seat says “Hey ICC” and then utters a request for the occupant Ub in a middle seat, sound of the request is output from the speaker 30b.

The microphone 20a R is one example of a first microphone. The microphone 20b R is one example of a second microphone. The speaker 30a is one example of a first speaker. The speaker 30b is one example of a second speaker. The association information of the memory 1224 includes information for associating the first microphone with the second speaker and information for associating the second microphone and the first speaker among a plurality of microphones and a plurality of speakers. According to the mode information illustrated in FIG. 2, the MW 1223 executes the following control, for example.

In a case where the ASR 1222 recognizes that sound input into the microphone 20a R (microphone ch: 1 ch) includes a specific word, the MW 1223 executes, on the basis of the association information, control (mode: front-seat→middle-seat mode) such that sound input into the microphone 20a_R subsequently to the specific word is output from the speaker 30b.

In a case where the ASR 1222 recognizes that sound input into the microphone 20b_R (microphone ch: 3 ch) includes a specific word, the MW 1223 executes, on the basis of the association information, control (mode: middle-seat→front-seat mode) such that sound input into the microphone 20b_R subsequently to the specific word is output from the speaker 30a.

As described above, in a case where sound input into one of a plurality of microphones provided in the vehicle interior includes a specific word, the MW 1223 inputs sound, which is further input into the microphone into which the sound is input, into the ICC-1way 1225 that is 1way-ICC solution. Next, the MW 1223 causes a speaker associated with the microphone to output sound that is output from the ICC-1way 1225.

Herein, the plurality of microphones and the plurality of speakers are respectively arranged in correspondence with a plurality of seats in the vehicle interior, the first microphone and the first speaker are arranged in correspondence with a first seat (for example, front seat), and the second microphone and the second speaker are arranged in correspondence with a second seat (for example, rear seat).

A procedure of the in-vehicle communication method according to the first embodiment will be explained with reference to FIG. 4. FIG. 4 is a flowchart illustrating a procedure of the in-vehicle communication method according to the first embodiment.

As illustrated in FIG. 4, the ASR 1222 executes speech recognition on sound that is input from each of a plurality of microphones (Step S101).

The MW 1223 determines whether or not sound of the ASR 1222 includes a specific word (Step S102). For example, the ASR 1222 generates text on the basis of sound of each of a plurality of channels, and if the text includes “Hey ICC”, informs the MW 1223 of a corresponding channel. In a case where there presents the above-mentioned notification, the MW 1223 determines that sound includes a specific word.

In a case where sound does not include a specific word (Step S102: No), the MW 1223 does not execute processes of Step S103 and thereafter. The ASR 1222 returns to Step S101, and continuously executes speech recognition.

On the other hand, in a case where sound includes a specific word (Step S102: Yes), the MW 1223 specifies a mode with reference to mode information, and further specifies a speaker indicated by the mode (Step S103). For example, a mode of “front-seat→middle-seat mode” corresponds to the speaker 30b arranged at a middle seat.

Moreover, the MW 1223 controls a selector such that sound is output from the specified speaker (Step S104).

For example, the MW 1223 controls the selector 1226 such that a sound signal of a channel corresponding to the microphone of Step S103 into which sound is input is input into the ICC-1way 1225.

Moreover, the MW 1223 controls the selector 1301 such that MIX is executed on a sound signal that is output from the speaker specified in Step S103 with a sound signal output from the ICC-1way 1225.

As described above, the in-vehicle communication device 10 according to the embodiment includes: a controller configured to execute control for selecting at least one speaker from among a plurality of speakers provided in a vehicle interior, the at least one speaker outputting sound that is input into one of a plurality of microphones provided in the vehicle interior; a sound recognizer that recognizes a word included in the sound; and a memory that stores therein association information that associates the plurality of microphones and the plurality of speakers with each other. The controller is further configured to: in a case where the sound recognizer recognizes that sound input into one of the plurality of microphones includes a specific word, based on the association information, execute control for causing a speaker of the plurality of speakers that is associated with the one microphone into which the sound is input, to output sound that is input subsequently to the specific word into the one microphone into which the sound is input.

Note that a plurality of speakers may be associated with a single microphone. For example, in FIG. 1, the speaker 30b of a middle seat and the speaker 30c of a rear seat may be associated with a microphone 20a of a front seat. In this case, in a case where an occupant in a front seat says “Hey ICC” to the microphone 20a, the subsequent utterance is output from both of the speaker 30b and the speaker 30c of the middle seat and the rear seat. Thus, an occupant in a front seat is able to talk to all of the occupants in seats of other rows in a vehicle. Similarly, a microphone 20b of a middle seat may be associated with both of the speakers 30a and 30c of a front seat and a rear seat, and a microphone 20c of a rear seat may be associated with both of the speakers 30a and 30b of a front seat and a middle seat.

In the first embodiment, bidirectional communication is realized between a front seat and a rear seat of a vehicle by using 1way-ICC solution whose processing load is smaller than that of 2way-ICC solution, so that it is possible to reduce processing load. Moreover, in a case where ICC-function is implemented by using hardware, a required circuit scale is small.

Furthermore, 2way-ICC solution is more expensive than 1way-ICC solution, so that it is possible to achieve cost reduction, according to the first embodiment.

Moreover, in a case of 2way-ICC solution, two interface channels for transmitting sound signals output from 2way-ICC solution to an amplifier are necessary. On the other hand, in the first embodiment, it is sufficient that a single interface channel is provided for transmitting a sound signal output from 1way-ICC solution to an amplifier.

If the number of interface channels for transmitting sound signals increases, load needed for communication accordingly increases.

Thus, according to the first embodiment, it is possible to reduce load needed for communication.

According to the first embodiment, even in a case where increase in an interface is realized by addition of a physical wire harness, it is possible to achieve effects that cost of the wire harness is reduced.

### Second Embodiment

In a second embodiment, a speaker of an output destination is specified in accordance with a recognized word in addition to a microphone. Thus, in a vehicle including three-row seats illustrated in FIG. 1, communication can be performed not only between a front seat and a middle seat, but also between an arbitrary combination of seats, for example, between a front seat and a rear seat, between a middle seat and a rear seat, and the like.

In the second embodiment, the association information includes information in which one of a plurality of microphones is associated with a group of speakers included in a plurality of speakers. In a case where the ASR 1222 recognizes that sound input into one of a plurality of microphones includes a specific word, the MW 1223 executes, on the basis of the association information, control for causing a group of speakers of a plurality of speakers, which is associated with the one microphone into which the sound is input, to output sound that is input subsequently to the specific word into the one microphone into which the sound is input.

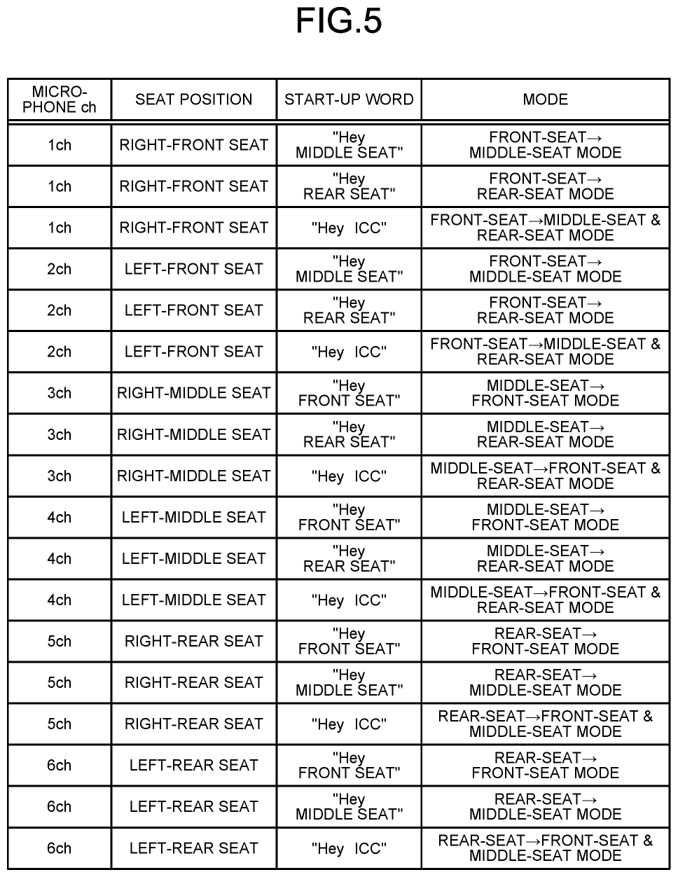

In the second embodiment, mode information illustrated in FIG. 5 is used. FIG. 5 is a diagram illustrating an example of mode information according to the second embodiment. In a case where a word recognized from sound is included in a start-up word in mode information, the MW 1223 specifies a mode that is corresponding to a microphone and the above-mentioned word.

For example, in a case where words of “Hey middle seat” are recognized from sound that is input into the microphone 20a_R arranged at a right-front seat, which corresponds to 1 ch, the MW 1223 specifies, with reference to the mode information, that a mode is “front-seat→middle-seat mode”. In this case, the MW 1223 controls a selector such that sound is output from the speaker 30b that corresponds to a middle seat.

For example, in a case where words of “Hey rear seat” are recognized from sound that is input into the microphone 20b_L arranged at a left-middle seat, which corresponds to 4 ch, the MW 1223 specifies, with reference to the mode information, that a mode is “middle-seat→rear-seat mode”. In this case, the MW 1223 controls a selector such that sound is output from the speaker 30c that corresponds to a rear seat.

For example, in a case where words of “Hey, middle seat” are recognized from sound that is input into the microphone 20c_R arranged at a right-rear seat, which corresponds to 5 ch, the MW 1223 specifies, with reference to the mode information, that a mode is “rear-seat→middle-seat mode”. In this case, the MW 1223 controls a selector such that sound is output from the speaker 30b that corresponds to a middle seat.

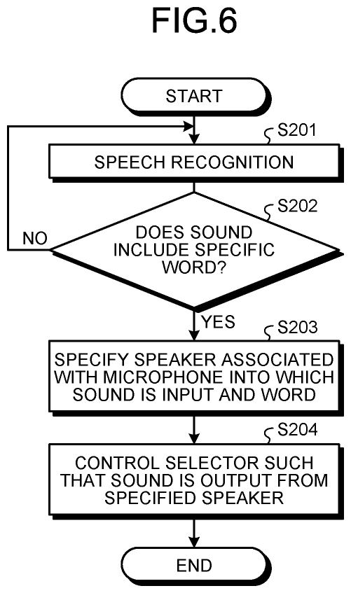

A procedure of an in-vehicle communication method according to the second embodiment will be explained with reference to FIG. 6. FIG. 6 is a flowchart illustrating a procedure of an in-vehicle communication method according to the second embodiment.

As illustrated in FIG. 6, the ASR 1222 executes speech recognition on each piece of sound input from a plurality of microphones (Step S201).

Herein, the MW 1223 determines whether or not the sound of the ASR 1222 includes a specific word (start-up word in mode information) (Step S202).

For example, the ASR 1222 generates text on the basis of each of sound signals of a plurality of channels, and if the text includes one of start-up words (“Hey front seat”, “Hey middle seat”, or “Hey rear seat”), informs the MW 1223 of a corresponding channel. In a case where there presents the notification, the MW 1223 determines that the sound includes a specific word.

In a case where the sound does not include a specific word (Step S202: No), the MW 1223 does not execute processes of Step S203 and thereafter. The ASR 1222 returns to Step S201, and continuously executes speech recognition.

On the other hand, in a case where sound includes a specific word (Step S202: Yes), the MW 1223 specifies a mode with reference to mode information, and further specifies a speaker indicated by the mode (Step S203). For example, a mode of “front-seat→middle-seat mode” corresponds to the speaker 30b arranged at a middle seat.

Note that in a case where a mode is denoted as “seat X→seat Y mode”, the MW 1223 may regard a speaker arranged at a seat Y that is in front of an arrow as a speaker corresponding to the mode. Moreover, a column that indicates information for identifying a speaker corresponding to a mode may be added to the mode information.

Furthermore, the MW 1223 controls a selector such that sound is output from the specified speaker (Step S204).

Similar to the first embodiment, also in the second embodiment, a plurality of speakers may be associated with a single microphone. For example, in FIG. 1, the speaker 30b of a middle seat and the speaker 30c of a rear seat may be associated with the microphone 20a of a front seat.

For example, if an occupant in a front seat utters, as a start-up word, words that does not specify a seat, such as “Hey ICC”, to the microphone 20a, the subsequent utterance may be output from both of the speaker 30b and the speaker 30c of a middle seat and a rear seat (corresponding to “front-seat→middle seat & rear-seat mode” illustrated in FIG. 5).

Thus, if using different start-up words, an occupant of a front seat is able to individually address an occupant of a seat in another row in a vehicle, and further is able to address all of the occupants. Similarly, the microphone 20b of a middle seat may be associated with both of the speakers 30a and 30c of a front seat and a rear seat (corresponding to “middle-seat→front-seat & rear-seat mode” illustrated in FIG. 5), and the microphone 20c of a rear seat may be associated with both of the speakers 30a and 30b of a front seat and a middle seat (corresponding to “rear-seat→front-seat & middle-seat mode” illustrated in FIG. 5).

As described above, the association information further includes information that associates one of a plurality of microphones with at least one speaker of a group of speakers for each type of a specific word. On the basis of the association information, the MW 1223 executes control such that sound is output from at least one speaker of speakers included in a group, which corresponds to a type of a specific word. Thus, a single microphone is capable of causing a group of speakers to output sound.

Herein, comparison between the first embodiment and the second embodiment will be explained. In the first embodiment, a single speaker is associated with a single microphone, and thus may be described below.

A plurality of microphones and a plurality of speakers are respectively provided to a plurality of seats in the vehicle interior, and the association information includes information that associates a speaker arranged in correspondence with a second seat (for example, rear seat) with a microphone arranged in correspondence with a first seat (for example, front seat).

On the other hand, in the second embodiment, a plurality of speakers is associated with a single microphone, and thus may be described below.

A plurality of microphones and a plurality of speakers are respectively provided to a plurality of seats in the vehicle interior, and the association information includes information that associates a group of speakers arranged in correspondence with seats excluding a first seat with a microphone arranged in correspondence with the first seat.

### Third Embodiment

In a third embodiment, a microphone and a speaker are preliminarily associated with each other, and a corresponding microphone is capable of responding to utterance output from a speaker.

Herein, the microphone 20a R is one example of a third microphone. The microphone 20b R is one example of a fourth microphone. The speaker 30a is one example of a third speaker. The speaker 30b is one example of a fourth speaker.

Assume that the microphone 20a R of a front seat and the speaker 30a of the front seat are preliminarily associated with each other. Assume that the microphone R of a middle seat and the speaker 30b of the middle seat are preliminarily associated with each other. Information for associating a microphone and a speaker with each other may be included in the mode information. In the third embodiment, the MW 1223 executes control as described below, for example.

Herein, the association information includes information that associates a third microphone and a fourth speaker of a plurality of microphones and a plurality of speakers with each other, and a fourth microphone and a third speaker of the plurality of microphones and the plurality of speakers with each other. In a case where the ASR 1222 recognizes that sound input into a third microphone includes a specific word, on the basis of association information, the MW 1223 executes control such that sound that is input subsequently to the specific word into a third microphone is output from a fourth speaker. After the ASR 1222 causes a fourth speaker to output sound, on the basis of association information, the MW 1223 executes control such that sound input into a fourth microphone associated with the fourth speaker is output from a third speaker associated with a third microphone.

In the third embodiment, speakers are arranged in correspondence with a plurality of seats in the vehicle interior, a third microphone and a third speaker are arranged in correspondence with the first seat, and a fourth microphone and a fourth speaker are arranged in correspondence with a second seat.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

According to the present disclosure, it is possible to reduce processing load for bidirectional communication between a front seat and a rear seat of a vehicle.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An in-vehicle communication device comprising:
a controller configured to execute control for selecting at least one speaker from among a plurality of speakers provided in a vehicle interior, the at least one speaker outputting sound that is input into one of a plurality of microphones provided in the vehicle interior;
a sound recognizer that recognizes a word included in the sound; and
a memory that stores therein association information that associates the plurality of microphones and the plurality of speakers with each other, wherein
the controller is further configured to:
in a case where the sound recognizer recognizes that sound input into one of the plurality of microphones includes a specific word, based on the association information, execute control for causing at least one of the plurality of speakers that is associated with the one microphone into which the sound is input, to output sound that is input subsequently to the specific word into the one microphone into which the sound is input.

2. The in-vehicle communication device according to claim 1, wherein
the association information includes information that associates, among the plurality of microphones and the plurality of speakers, a first microphone and a second speaker with each other, and a second microphone and a first speaker with each other, and
the controller is further configured to:
in a case where the sound recognizer recognizes that sound input into the first microphone includes the specific word, based on the association information, execute control for causing the second speaker to output sound that is input subsequently to the specific word input into the first microphone; and
in a case where the sound recognizer recognizes that sound input into the second microphone includes the specific word, based on the association information, execute control for causing the first speaker to output sound that is input subsequently to the specific word input into the second microphone.

3. The in-vehicle communication device according to claim 1, wherein
the association information includes information that associates one of the plurality of microphones with a group of speakers included in the plurality of speakers, and
the controller is further configured to:
in a case where the sound recognizer recognizes that sound input into one of the plurality of microphones includes the specific word, based on the association information, execute control such that sound input subsequently to the specific word into the one microphone into which the sound is input is output from the group of speakers of the plurality of speakers associated with the one microphone into which the sound is input.

4. The in-vehicle communication device according to claim 3, wherein
the association information further includes information that associates, for each type of the specific word, one of the plurality of microphones with at least one speaker of the group of speakers, and
the controller is further configured to:
based on the association information, execute control such that the sound is output from at least one speaker of speakers included in the group corresponding to a type of the specific word.

5. The in-vehicle communication device according to claim 1, wherein
the association information includes information that associates, among the plurality of microphones and the plurality of speakers, a third microphone and a fourth microphone with each other, and a fourth speaker and a third speaker with each other, and
the controller is further configured to:
in a case where the sound recognizer recognizes that sound input into the third microphone includes the specific word, based on the association information, execute control such that sound input subsequent to the specific word into the third microphone is output from the fourth speaker; and
after the sound recognizer causes the fourth speaker to output sound, based on the association information, execute control such that sound input into the fourth microphone associated with the fourth speaker is output from the third speaker associated with the third microphone.

6. The in-vehicle communication device according to claim 1, wherein
the plurality of microphones and the plurality of speakers are respectively provided to a plurality of seats in the vehicle interior, and
the association information includes information that associates a speaker arranged in correspondence with a second seat with a microphone arranged in correspondence with a first seat.

7. The in-vehicle communication device according to claim 2, wherein
the plurality of microphones and the plurality of speakers are respectively arranged in correspondence with a plurality of seats in the vehicle interior, and
the first microphone and the first speaker are arranged in correspondence with a first seat, and the second microphone and the second speaker are arranged in correspondence with a second seat.

8. The in-vehicle communication device according to claim 3, wherein
the plurality of microphones and the plurality of speakers are respectively provided to a plurality of seats in the vehicle interior, and
the association information includes information that associates a group of speakers arranged in correspondence with seats excluding a first seat with a microphone arranged in correspondence with the first seat.

9. The in-vehicle communication device according to claim 5, wherein
the plurality of microphones and the plurality of speakers are respectively provided to a plurality of seats in the vehicle interior, and
the third microphone and the third speaker are arranged in correspondence with a first seat, and the fourth microphone and the fourth speaker are arranged in correspondence with a second seat.

10. A non-transitory computer-readable recording medium having stored therein an in-vehicle communication program that causes a computer to execute a process comprising:
in a case where sound input into one of a plurality of microphones provided in a vehicle interior includes a specific word, based on the association information that associates the plurality of microphones and a plurality of speakers provided in a vehicle interior with each other, causing a speaker associated with the one microphone into which the sound is input to output sound input subsequently to the specific word into the one microphone into which the sound is input.

11. An in-vehicle communication device comprising:
a sound recognizer that recognizes a plurality of specific words included in sound input from a microphone provided in a vehicle interior;
a memory that stores therein association information that associates a plurality of speakers provided in the vehicle interior with the plurality of specific words respectively; and
a controller that causes a speaker associated with the specific word to output sound input from the microphone following the specific word recognized by the recognizer, in accordance with the association information stored in the memory.
